(19) United States
(12) Patent Application Publication
(10) Pub. No.: US 2007/0147772 A1
(43) Pub. Date: Jun. 28, 2007

(54) Broadcast recording apparatus and broadcast recording method

(76) Inventor: Takashi Kitamura, Fukaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/644,886

(22) Filed: Dec. 26, 2006

(30) Foreign Application Priority Data
Dec. 27, 2005 (JP) 2005-374600

(51) Int. Cl. H04N 5/91

(52) U.S. Cl. 386/83

(57) ABSTRACT

According to one embodiment, a broadcast recording apparatus includes a tuner unit which receives a broadcast signal, demodulates the received signal, and outputs a plurality of broadcast contents, a recording unit which records the plurality of broadcast contents from the tuner unit, and a control which that makes control to output a display signal to display in listings (FIG. 2) management information on the plurality of broadcast contents recorded by the recording unit, and to output a display signal to display in listings, in time series, management information on a plurality of broadcast contents associated with broadcast contents instructed to be reproduced, from the plurality of the recorded broadcast contents upon receiving an operating signal for instructing one reproduction in the plurality of the broadcast contents.

### CROSS-REFERENCE TO RELATED APPLICATIONS

This application is based upon and claims the benefit of priority from Japanese Patent Application No. 2005-374600, filed Dec. 27, 2005, the entire contents of which are incorporated herein by reference.

### BACKGROUND

1. Field

One embodiment of the invention relates to a broadcast recording apparatus for recording broadcast contents, and particularly to a broadcast recording apparatus displaying a plurality of broadcast contents associated with each other in listings, and a broadcast recording method.

2. Description of the Related Art

Recently, with prevalence of a digital device, a broadcast receiving apparatus such as a hard disk recorder has been generally known, making it possible to easily record/reproduce much more video image information than the case of a recording/reproducing processing operation using a conventional video tape recorder (VTR). In such a broadcast receiving apparatus, reservation image recording or the like is enabled by simple operation so that a tremendously large amount of broadcast contents can be stored in a memory region. As a result, there can be a situation in which broadcast contents recorded by a user as an image cannot be sufficiently grasped.

In patent document 1 (Jpn. Pat. Appln. KOKAI Publication No. 2003-319308), there is provided a recording apparatus in which, in response to such a situation, for example, at the time of reproducing a specific program, in the case where a previous program of that specific program is reproduced, all of un-reproduced programs can be viewed by making a question that “Program series of last week is not reproduced yet. Which of the program series do you want to reproduce?”

However, in an apparatus of patent document 1, there is a problem that, although it is known whether or not an un-reproduced program of last week exists, it is impossible to easily acquire information on what proportion of the whole program series is recorded or what proportion has been reproduced.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram depicting an example of a configuration of a broadcast recording apparatus according to an embodiment of the present invention;

FIG. 2 is an illustrative view showing an example of displaying in listings the broadcast contents possessed by the broadcast recording apparatus;

FIG. 3 is an illustrative view showing an example of displaying in listings the broadcast contents possessed by the broadcast recording apparatus;

FIG. 4 is an illustrative view showing an example of displaying in listings the broadcast contents possessed by the broadcast recording apparatus;

FIG. 5 is an illustrative view showing an example of displaying in listings the broadcast contents possessed by the broadcast recording apparatus;

FIG. 6 is a flow chart showing an example of a list display processing operation carried out by the broadcast recording apparatus;

FIG. 7 is a flow chart showing an example of a list display processing operation (protecting flag) carried out by the broadcast recording apparatus; and

FIG. 8 is an illustrative view showing an example of a remote controller device for operating the broadcast recording apparatus.

### DETAILED DESCRIPTION

Various embodiments according to the invention will be described hereinafter with reference to the accompanying drawings. In general, according to one embodiment of the invention, there is provided a broadcast recording apparatus, comprising: a tuner unit which receives a broadcast signal, demodulates the received signal, and outputs a plurality of broadcast contents; a recording unit which records said plurality of broadcast contents from the tuner unit; and a control unit which makes control to output a display signal to display in listings management information on said plurality of broadcast contents recorded by the recording unit, and to output a display signal to display in listings, in time series, management information on a plurality of broadcast contents associated with broadcast contents instructed to be reproduced, from said plurality of the recorded broadcast contents upon receiving an operating signal for instructing one reproduction in said plurality of the broadcast contents.

Contents associated with those to be reproduced by a user are automatically displayed in listings, thus making it possible to very easily know a situation of contents possessed by the user. For example, it is possible to reliably avoid a situation in which a user views a fifth round of drama before unviewed dramas of third and fourth rounds. Hereinafter, embodiments of the present invention will be described in detail with reference to the accompanying drawings.

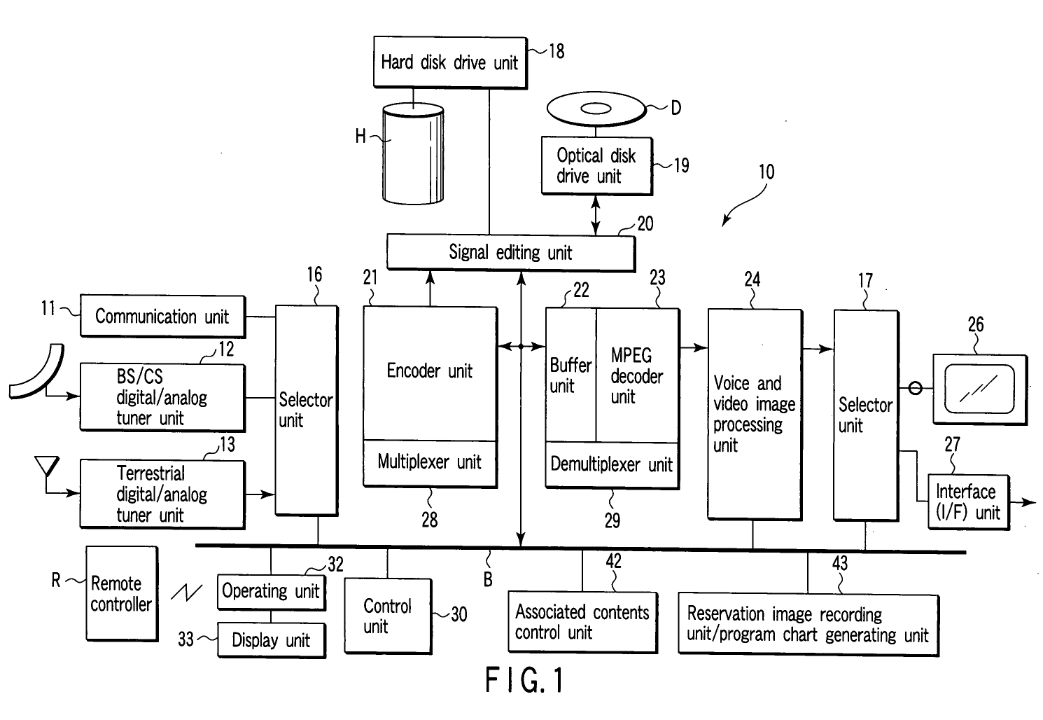

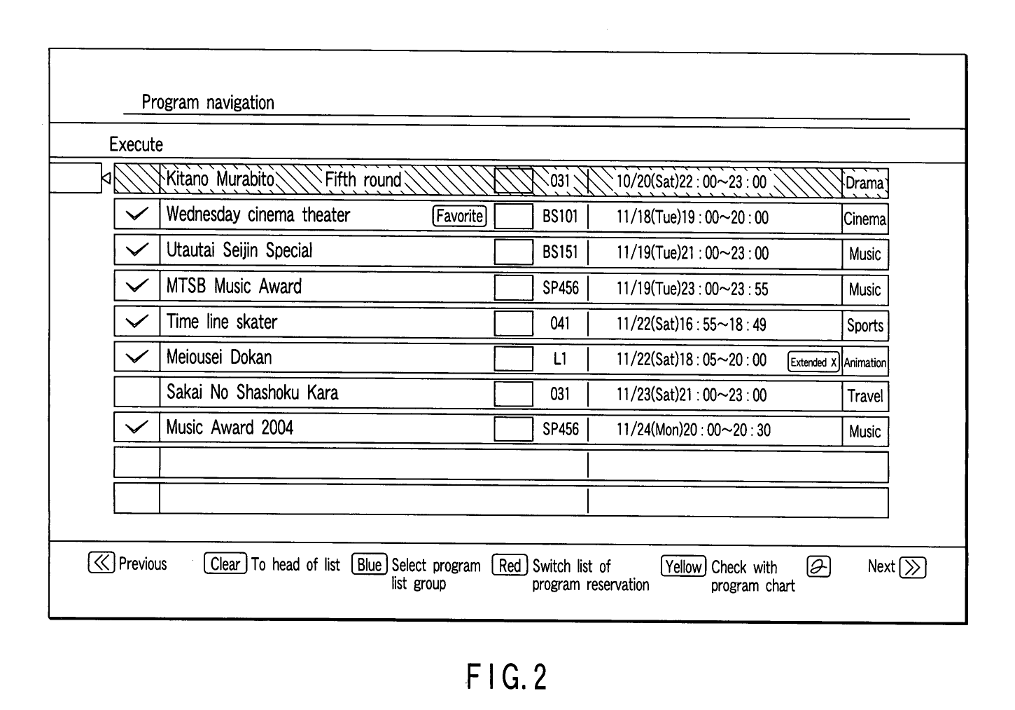

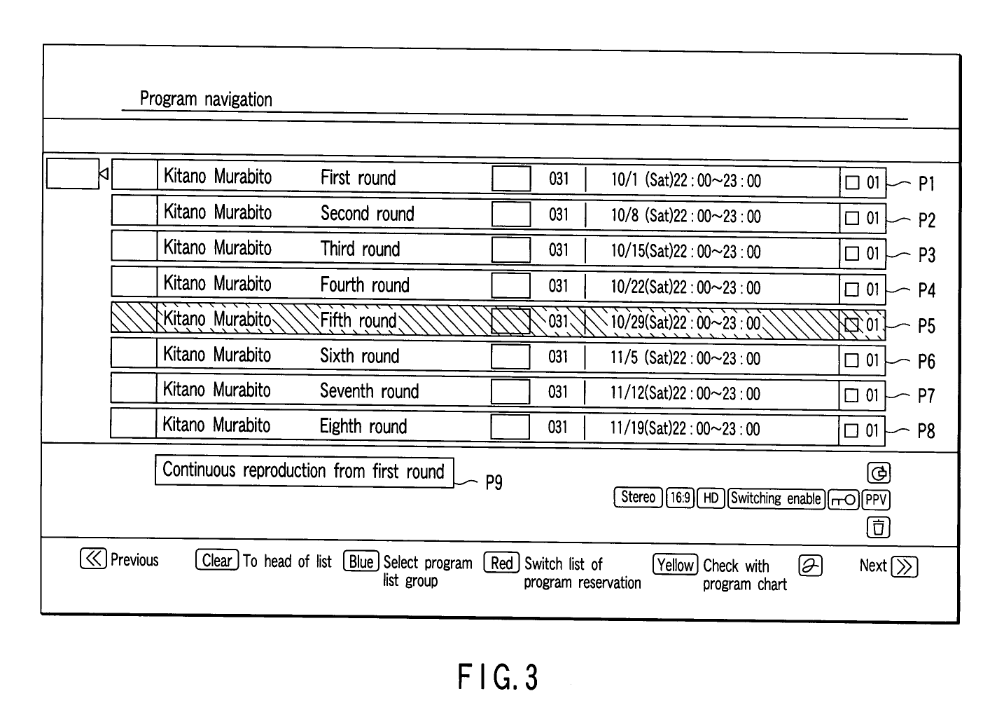

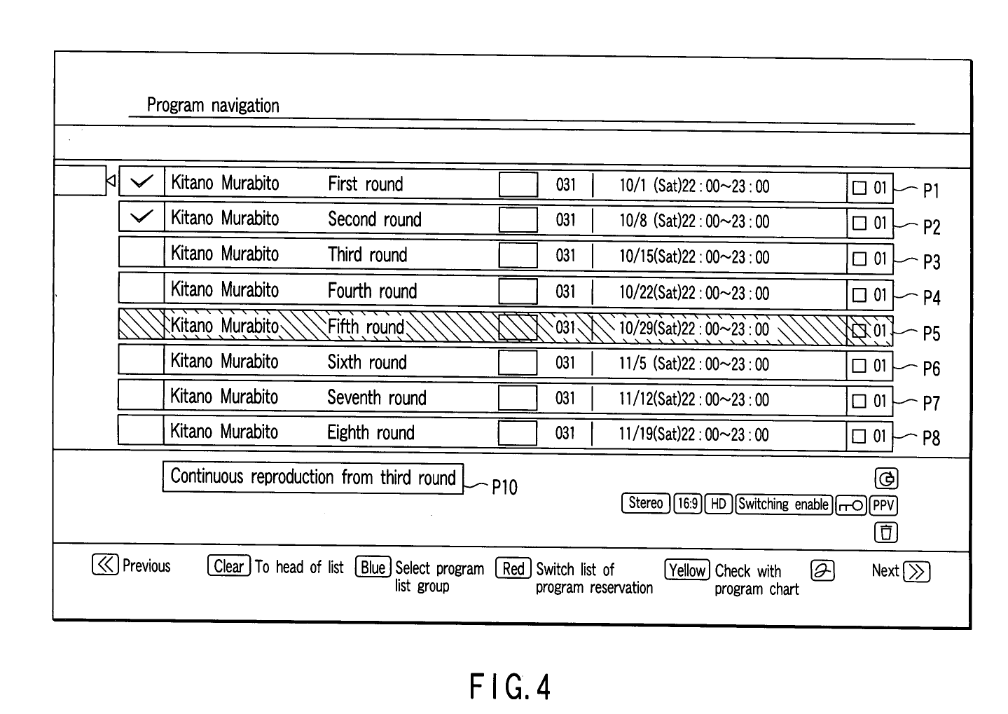

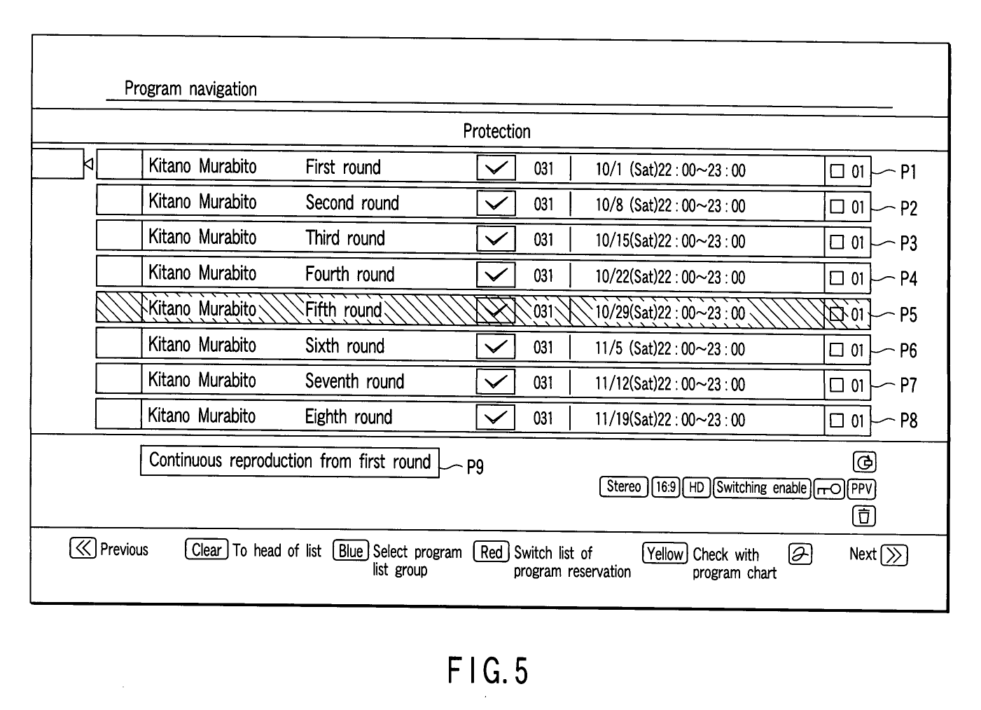

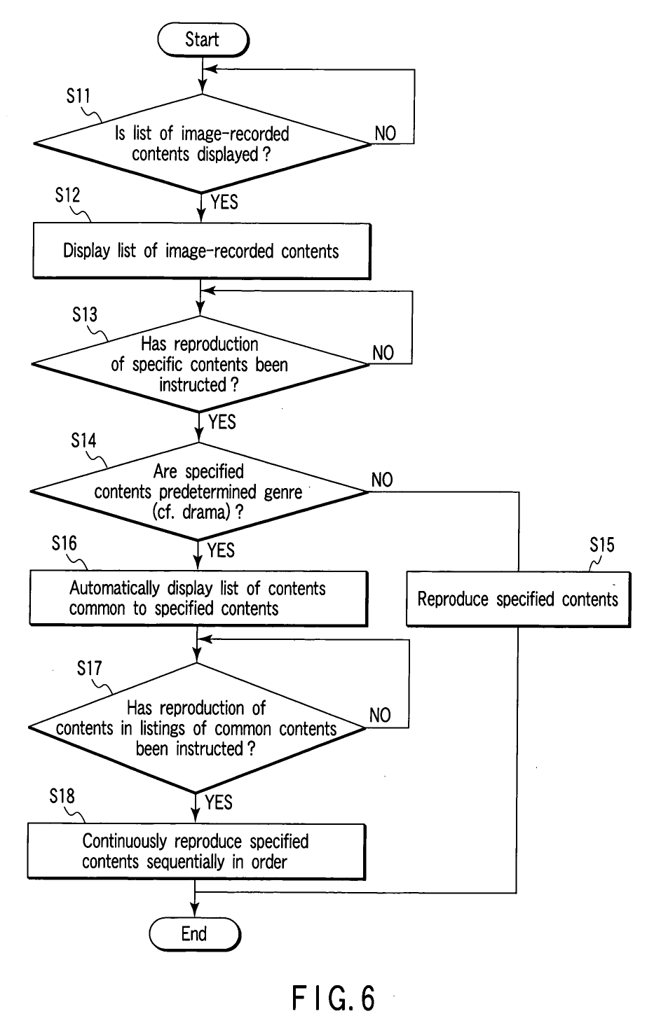

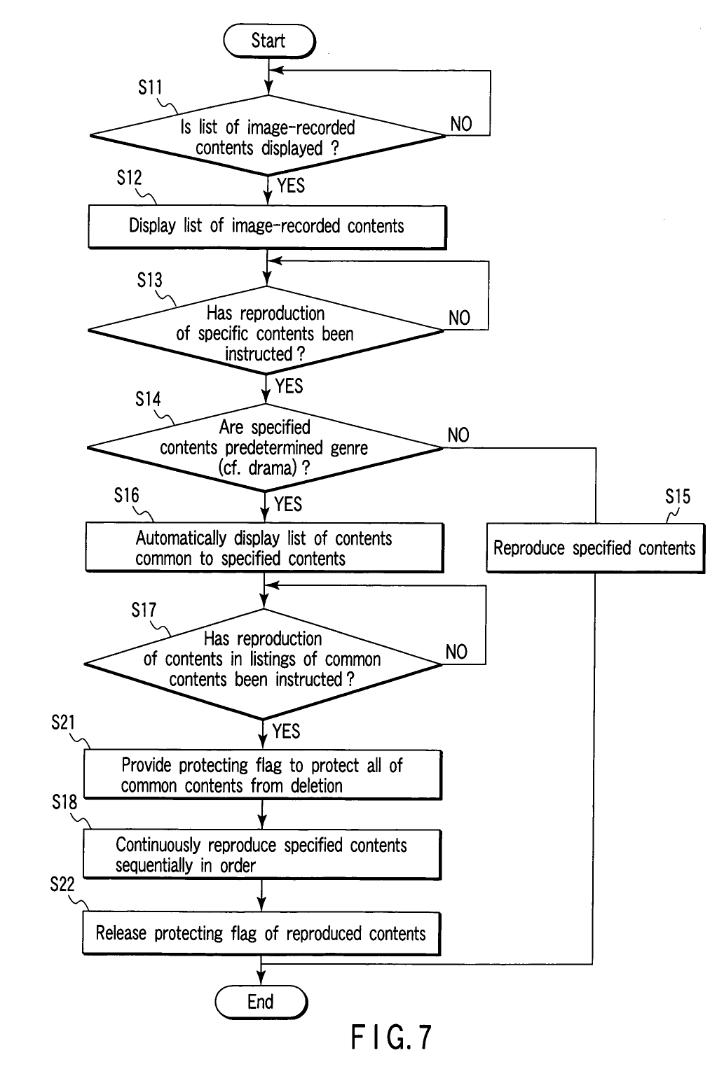

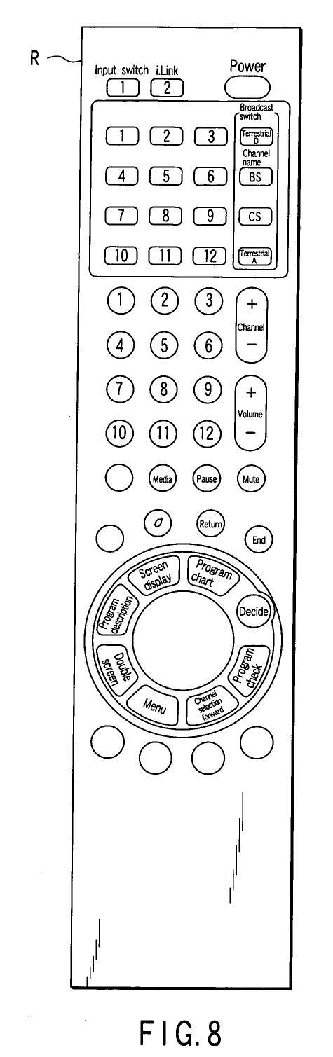

That is, FIG. 1 is a block diagram depicting an example of a configuration of a broadcast recording apparatus according to an embodiment of the present invention; FIG. 2 is an illustrative view showing an example of displaying in listings the broadcast contents possessed by the broadcast recording apparatus; FIG. 3 is an illustrative view showing an example of displaying in listings the broadcast contents possessed by the broadcast recording apparatus; FIG. 4 is an illustrative view showing an example of displaying in listings the broadcast contents possessed by the broadcast recording apparatus; FIG. 5 is-an illustrative view showing an example of displaying in listings the broadcast contents possessed by the broadcast recording apparatus; FIG. 6 is a flow chart showing an example of a list display processing operation carried out by the broadcast recording apparatus; FIG. 7 is a flow chart showing an example of a list display processing operation (protecting flag) carried out by the broadcast recording apparatus; and FIG. 8 is an illustrative view showing an example of a remote controller device for operating the broadcast recording apparatus.

<Broadcast Recording Apparatus According to an Embodiment of the Present Invention>

(Configuration)

First, a broadcast recording apparatus 10 shown in FIG. 1 is provided as an example of a digital television having a recording function while a tuner or the like is used as a source. However, a hard disk recorder having a tuner or the like and a recording function is also preferred similarly.

Therefore, while the following embodiments with reference to FIG. 1 will describe in detail a digital television having a recording function, it is possible to construe the embodiments as an explanation of a hard disk recorder having completely identical capabilities by separating a display 26 from the constituent elements shown in FIG. 1.

In FIG. 1, the broadcast recording apparatus 10 serving as a digital television has two types of disk drives. First, this apparatus has a hard disk drive unit 18 for driving a hard disk H as a first medium. Secondly, this apparatus has an optical disk drive unit 19 for rotationally driving an optical disk D as a second medium that is an information recording medium capable of constructing a video file, and then, executing information read and write operations. In addition, a control unit 30 is connected to each unit via a data bus B to control a whole operation. However, in the case of carrying out the present invention, the optical disk drive unit 19 is not always a required constituent element.

In addition, the broadcast recording apparatus 10 shown in FIG. 1 primarily comprises: an encoder unit 21 that configures an image recording side; an MPEG decoder unit 23 that configures a reproduction side; and a control unit 30 that controls an operation of an apparatus main body. The broadcast recording apparatus 10 has an input side selector 16 and an output side selector 17. A communication unit 11 such as a LAN, a so called satellite broadcast (BS/CS) digital/analog tuner unit 12, and a so called terrestrial digital/analog tuner unit 13 are connected to the input side selector 16, thereby outputting a signal to the encoder unit 21. In addition, a satellite antenna is connected to the BS/CS digital/analog tuner unit 12 and a terrestrial antenna is connected to the terrestrial digital/analog tuner unit 13. In addition, the broadcast recording apparatus 10 has: an encoder unit 21; a signal editing unit 20 for receiving an output from the encoder unit 21, and then, carrying out desired data processing such as data editing; a hard disk drive unit 18 connected to the signal editing unit 20; and the optical disk drive unit 19. Further, the broadcast recording apparatus 10 has: a hard disk drive unit 18; an MPEG decoder unit 23 for receiving and decoding a signal from the optical disk drive unit 19; an encoder unit 21; a buffer unit 22; an MPEG decoder unit 23; a multiplexer unit 28; a demultiplexer unit 29; a control unit 30; an associated contents control unit 42; and a reservation image recording/program chart generating unit 43. These units each are connected to the control unit 30 via the data bus B. Further, an output from the selector unit 17 is supplied to a display 26 or is supplied to an external device via an interface unit 27 for making communication with the external device.

Further, the broadcast recording apparatus 10 has an operating unit 32 connected to the control unit 30 via the data bus B and receiving a user operation or an operation of a remote controller R. Here, the remote controller R enables operations that are substantially identical to those of the operating unit 32 provided at a main body of the broadcast recording apparatus 10. This remote controller enables a variety of settings such as supply of a recording or reproducing command for the hard disk drive unit 18 or the optical disk drive unit 19, supply of an edit command, a tuner operation, reservation image recording setting and-the-like.

(Basic Operation)

Reproduction of Broadcast Contents

In the broadcast recording apparatus 10 serving as the thus configured digital television, in accordance with an operating signal responsive to an operation of a user's remote controller R or the operating unit 32, a broadcast signal is received, and then, the broadcast contents from the BS/CS tuner unit 12 or the terrestrial digital/analog tuner unit 13 are displayed on the display 26, under the control of the control unit 30 or the like.

Recording Processing Operation

Now, an operation at the time of recording including those according to other embodiments will be described in detail. As an input side of the broadcast recording apparatus 10, a communication unit 11 such as a LAN is connected to an external device, thereby making communication with a program information providing server S or the like through a communication channel such as the Internet via a modem M or the like, or downloading broadcast contents or the like. In addition, the BS/CS digital/analog tuner unit 12 and the terrestrial digital/analog tuner unit 13 select a broadcast signal as a channel and demodulate it via an antenna, and input a video image signal and a voice signal. These tuner units cover diversified types of broadcast signals. For example, the tuner units cover a terrestrial analog broadcast, a terrestrial digital broadcast, a BS analog broadcast, a BS digital broadcast, a CS digital broadcast and the like without being limited thereto. In addition, there is not necessarily provided only one tuner unit. For example, two or three tuner units such as a terrestrial broadcast tuner unit and a BS/CS tuner unit may be provided to function in parallel to each other in response to a request for reservation image recording.

The previously described communication unit 11 may be an IEEE1394 interface and is capable of receiving digital contents from an external device over a network. In addition, it is also possible to receive a luminance signal, a color difference signal, a video image signal such as a composite signal, and a voice signal from an input terminal (not shown). These signals are selectively supplied to the encoder unit 21 by means of the selector 16 controlled by the control unit 30 or the like while inputs are controlled.

The encoder unit 21 has: a video use and an audio use analog/digital converter for digitizing an analog video signal or an analog audio signal inputted by means of the selector 16; a video encoder, and an audio encoder. For example, a subsidiary video image encoder is also included. An output from the encoder 21 is converted into a compression format such as predetermined MP-EG, and the converted output is supplied to the previously described control unit 30.

In addition, the BS/CS analog/digital tuner 12 or the like is not always incorporated. Preferably, this tuner is externally provided via a data input terminal to supply the received digital signal to the encoder unit 21 or the control unit 30 via the selector unit 16.

Here, the apparatus shown in FIG. 1 supplies information (pack such as video, audio, and subsidiary video image data) encoded by the encoder unit 21 and produced management information to the hard disk drive unit 18 or the optical disk drive unit 19 via the control unit 30 so that the supplied items of information can be recorded in the hard disk drive unit 18 or the optical disk D. In addition, the information recorded in the hard disk drive unit 18 or the optical disk D can also be recorded in the optical disk D or the hard disk drive unit 18 via the control unit 30 or the optical disk drive unit 19.

The signal editing unit 20 is capable of making an edit processing operation such as partially deleting video objects of a plurality of programs recorded in the hard disk drive unit 18 or the optical disk D or connecting objects of different programs with each other.

Reproducing Processing Operation or the Like

Now a processing operation of reproducing recorded information including those according to other embodiments will mainly be described in detail. The MPEG decoder unit 23 comprises a video processor for properly combining a decoded subsidiary video image with a decoded main video image, and then, superimposing a menu, a highlight button, subtitles or any other subsidiary video image on a main video image to be outputted.

An output audio signal of the MPEG decoder unit 23 is supplied to a speaker after being analog-converted by means of a digital/analog converter (not shown), via the selector unit 17 or is supplied to an external device via the I/F 27. The selector unit 17 is controlled by a select signal from the control unit 30. In this manner, the selector unit 17 can directly select a signal having passed through the encoder unit 21 when a digital signal from each of the tuner units 12 and 13 is directly monitored.

Reservation Image Recording Processing Operation

In addition, based on electronic program information acquired from the communication unit 11 or the tuners 12 and 13, an image recording reservation processing operation can be made by means of the reservation image recording unit (program chart generating unit) 43 in response to a program specified by an operation of a user's remote controller R or the like. At the same time, it is possible to display on a screen a program chart based on the acquired electronic program information. Further, based on the reserved reservation image recording information and by working of the control unit 30 and the reservation image recording unit 43, when a reservation time has come, video image and voice signals produced when the program information received by the BS/CS digital/analog tuner unit 12 or the terrestrial digital/analog tuner unit 13 is demodulated is recorded (reserved and recorded as images) in the hard disk unit H, for example, through an encode processing operation of the encoder 21 or the like.

The broadcast recording apparatus 10 according to the present embodiment has the thus comprehensive functions and carries out a recording/reproducing processing operation by an optical disk D or the hard disk unit H with respect to a plurality of sources.

<Displaying in Listings the Broadcast Contents According to an Embodiment of the Present Invention>

Now, with reference to the accompanying drawings, a detailed description will be given with respect to displaying in listings the broadcast contents according to an embodiment of the present invention. Here, a function of displaying broadcast contents in listings is defined as follows. When broadcast contents among a plurality of broadcast contents possessed by a user include broadcast contents associated with those to be reproduced, or specifically, when broadcast contents are a drama of fifth round, it is judged whether or not broadcast contents of another round exist in the plurality of broadcast contents possessed by the user. If the contents exist, the associated broadcast contents are displayed in listings before supplying the user's instruction, and then, equipment waits for the user's instruction.

Now, the above operation will be described in detail with reference to the accompanying drawings and flow charts. A broadcast recording apparatus 10 (this apparatus can be considered to be a hard disk recorder, as described above) serving as a digital television according to an embodiment of the present invention is capable of automatically reserving and image-recording a very large amount of broadcast contents by a reservation image recording unit (program chart generating unit) 43 based on electronic program information acquired from a communication unit 11 or the like. In addition, it may be possible that a large amount of broadcast contents are stored in a hard disk H in a state in which they cannot be sufficiently grasped by a user.

In such a situation, the user makes an operation of a remote controller R or an operating unit 32 shown in FIG. 8 (step S11) to reproduce the broadcast contents possessed by the user or to display image-recorded broadcast contents as shown in FIG. 2. Upon receiving an operating signal, a control unit 30 acquires management information on broadcast contents stored in a memory region or a hard disk unit H of a reservation image recording unit 43; generates a display signal based on these items of the management information; and then, supplies the generated display signal to a voice and video image processing unit 24, thereby displaying a list of image-recorded broadcast contents as shown in FIG. 2 on a display 26 (step S12). This list of image-recorded broadcast contents merely displays part of the possessed broadcast contents, thus making it impossible for the user to sufficiently understand what proportion of the whole broadcast contents exist.

However, the user has an interest in a drama “Kitano Murabito (fifth round)”, makes an operation of the remote controller R to reproduce this drama, specifies this drama, and depresses a reproduction key. In this manner, the control unit 30 recognizes that reproduction of the broadcast contents has been instructed (step S13).

Next, the control unit 30 identifies a broadcast genre of the broadcast contents in collaboration with an associated contents control unit 42; recognizes that this is a “drama” which is a predetermined genre designated in advance; and moves to the subsequent associated list display step (step S14). In the case where the broadcast genre of the broadcast contents is not a predetermined genre that is designated in advance such as “news” or the like, for example, a general reproduction processing operation is carried out by operations of the control unit 30 and the hard disk drive unit 18 or an MPEG decoder 23 (step S15).

Here, it is preferable that the broadcast genre of broadcast contents be management information automatically acquired from the above described electronic program information. In addition, although it is preferable that the broadcast genre of broadcast contents be at least a “drama”, it is preferable that the genre be a continuous broadcast genre such as an “animation”, for example, without being limited to drama. However, a specific genre such as “sports” may be additionally set by the user's operation using the remote controller R or the like. In addition, it is preferable to release a specified genre by the user's operation.

In step S14, when the control unit 30 identifies a broadcast genre of the broadcast contents in collaboration with the associated contents control unit 42, and then, recognizes that this is a “drama” which is a predetermined genre designated in advance, the control unit generates a display signal for displaying in listings the broadcast contents common to the designated broadcast contents as shown in FIG. 3, and displays the listed broadcast contents on the display 26 (step S16). In FIG. 3, “Kitano Murabito (fifth round)” designated for reproduction in advance is selectively displayed, and at the same time, “Kitano Murabito (first round)” to “Kitano Murabito (eighth round)” P1 to P8 that are other associated broadcast contents are automatically displayed in listings on a screen.

As a criterion for judging association between one broadcast content and another broadcast content, it is preferable that each one of “title”, “day of the week for image recording”, “image recording time”, and “image recording channel” completely matches each other as an example. However, slight modification such as the fact that three among these four items are common is preferred similarly.

In this list display shown in FIG. 3, when an icon of “continuous reproduction from first round” P9 is further displayed, and then, a user's icon is specified (step S17), it is preferable to carry out auto continuous reproduction in accordance with the recording sequence of “Kitano Murabito (first round)” to “Kitano Murabito (eighth round)” P1 to P8 in operations of the control unit 30 and the associated contents control unit 42. Alternatively, for example, auto continuous reproduction from “Kitano Murabito (third round)” P3 or the like specified by the user's operation is carried out (step S18).

In addition, as shown in FIG. 4, in the case where dramas of first and second rounds have been already viewed and the rest of the drams are unviewed, it is possible to display a viewing status on a screen. In this case, although it is preferable to display an icon P10 indicating “continuous reproduction from third round”, this reproduction may be merely “continuous reproduction of unviewed broadcast contents”. In addition, it is possible to indicate a display promoting viewing such as color differentiation with respect to a region of unviewed broadcast contents.

In this manner, the user merely instructs reproduction from an image-recorded broadcast contents list display (FIG. 2), whereby a list display (FIG. 3) of associated broadcast contents is automatically displayed. Thus, the user can easily understand a situation of all of the associated broadcast contents. Thus, for example, it is possible to avoid a problem that a drama of a fifth round is viewed without viewing unviewed drams of third and fourth rounds, reducing an interest with respect to the dramas of third and fourth rounds.

Furthermore, as shown in a flow chart of FIG. 7, an auto assignment processing operation of protecting flags is preferred. The flow chart shown in each of FIGS. 6 and 7 is common to each other in each of steps S11 to S17. A duplicate description is omitted. A description is given with respect to only the subsequent processing operations.

That is, in step S17 in the flow chart shown in FIG. 7, as shown in the listings shown in FIG. 3, when icons such as “continuous reproduction from first round” P9 or the like have been displayed, and an instruction for reproducing broadcast contents occurs (step S17), a protecting flag is provided to protect all of common broadcast contents from deletion, as shown in FIG. 5 (step S21). Then, the designated broadcast contents are continuously reproduced sequentially in order (step S18). Then, although it is desirable to automatically release a protecting flag of the reproduced contents, this flag may be released after the user's instruction (step S22). In this manner, it is possible to automatically avoid a failure that the broadcast contents intended to be reproduced by a user are deleted for some reason.

One skilled in the art can achieve the present embodiments in accordance with a variety of the embodiments described above. Further, a variety of modified examples of these embodiments can be easily conceived by one skilled in the art, making it possible to apply to a variety of embodiments even if one does not have any inventive ability. Therefore, the present invention covers a broad scope without departing from the disclosed principle and novel features, and is not limited to the embodiments described above.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A broadcast recording apparatus, comprising:
a tuner unit which receives a broadcast signal, demodulates the received signal, and outputs a plurality of broadcast contents;
a recording unit which records said plurality of broadcast contents from the tuner unit; and
a control unit which makes control to output a display signal to display in listings management information on said plurality of broadcast contents recorded by the recording unit, and to output a display signal to display in listings, in time series, management information on a plurality of broadcast contents associated with broadcast contents instructed to be reproduced, from said plurality of the recorded broadcast contents upon receiving an operating signal for instructing one reproduction in said plurality of the broadcast contents.

2. The broadcast recording apparatus according to claim 1, wherein the control unit outputs a display signal to display in listings, in time series, management information on a plurality of broadcast contents associated with the broadcast contents instructed to be reproduced only in the case where the contents instructed to be reproduced are contents of a specific broadcast genre.

3. The broadcast recording apparatus according to claim 2, wherein the specific broadcast genre is a drama.

4. The broadcast recording apparatus according to claim 2, wherein the specific broadcast genre can be determined in response to an operating signal.

5. The broadcast recording apparatus according to claim 1, wherein the control unit judges that, in the case where contents have a title, a day of the week for image recording, an image recording time, and an image recording channel in common with those of the broadcast contents instructed to be reproduced, the contents are the associated contents.

6. The broadcast recording apparatus according to claim 1, wherein the control units makes control to continuously reproduce, in order of recording, un-reproduced contents among a plurality of broadcast contents associated with the broadcast contents instructed to be reproduced.

7. The broadcast recording apparatus according to claim 1, wherein the control unit makes control to automatically protect from deletion a plurality of broadcast contents associated with the broadcast contents instructed to be reproduced.

8. The broadcast recording apparatus according to claim 1, wherein the broadcast recording apparatus is a television apparatus comprising a display and a recording/reproducing function.

9. A broadcast recording method comprising:
recording broadcast contents obtained by demodulating a broadcast signal;
outputting a display signal to display in listings management information on a plurality of the recorded broadcast contents; and
outputting a display signal to display in listings, in time series, management information on a plurality of broadcast contents associated with broadcast contents instructed to be reproduced, from said plurality of the recorded broadcast contents upon receiving an operating signal for instructing one reproduction in said plurality of the broadcast contents.

10. The broadcast recording method according to claim 9, wherein a display signal to display in listings, in time series, management information on a plurality of broadcast contents associated with the broadcast contents instructed to be reproduced is outputted only in the case where the-contents instructed to be reproduced is contents of a specific broadcast genre.

11. The broadcast recording method according to claim 10, wherein the specific broadcast genre is a drama.

12. The broadcast recording method according to claim 10, wherein the specific broadcast genre can be determined in response to an operating signal.

13. The broadcast recording method according to claim 9, wherein, it is judged that, in the case where contents have a title, a day of the week for image recording, an image recording time, and an image recording channel in common with those of the broadcast contents instructed to be reproduced, the contents are the associated contents.

14. The broadcast recording method according to claim 9, wherein control is made to continuously reproduce, in order of recording, un-reproduced contents among a plurality of broadcast contents associated with the broadcast contents instructed to be reproduced.
